(19) United States
(12) Patent Application Publication
(10) Pub. No.: US 2026/0011723 A1
(43) Pub. Date: Jan. 8, 2026

(54) Li Mn-RICH CATHODE FOR HIGH ENERGY Li-ION BATTERY

(71) Applicant: Samsung SDI Co., Ltd., Yongin-si (KR)

(72) Inventors: Zijian CAI, Cambridge, MA (US); Qingjie Li, Arlington, MA (US); Yan Wang, Brookline, MA (US); Michael Chon, Medford, MA (US)

(73) Assignee: Samsung SDI Co., Ltd., Yongin-si (KR)

(21) Appl. No.: 19/086,864

(22) Filed: Mar. 21, 2025

Related U.S. Application Data
(60) Provisional application No. 63/668,487, filed on Jul. 8, 2024.

(51) Int. Cl. H01M 4/505; C01G 53/50; C01G 53/502; H01M 10/0525

(52) U.S. Cl. CPC H01M 4/505; C01G 53/50; C01G 53/502; H01M 10/0525; C01P 2002/52; C01P 2002/54; C01P 2002/72; C01P 2006/40

(57) ABSTRACT

A compound for use in a lithium, manganese-rich cathode for a Li-ion battery is doped Li_{1.2}Ni_{0.2}Mn_{0.6}O₂ including Li_{1.2}Ni_{0.2}Mn_{0.6}O₂ doped with Na⁺, Li_{1.2}Ni_{0.2}Mn_{0.6}O₂ doped with Co³⁺, or Li_{1.2}Ni_{0.2}Mn_{0.6}O₂ dual doped with Na⁺ and Co³⁺. A lithium, manganese-rich cathode for an Li-ion battery includes the aforementioned compound. A lithium-ion battery includes an anode, a cathode, and an electrolyte, wherein the cathode is the aforementioned lithium, manganese-rich cathode.

### CROSS-REFERENCE TO RELATED APPLICATION

This application is based on and claims priority from U.S. Provisional Application No. 63/668,487 filed on Jul. 8, 2024 in the U.S. Patent and Trademark Office, the disclosure of which is incorporated herein by reference in its entirety.

### BACKGROUND

### 1. Field

Embodiments of the present disclosure relate to compounds for use in cathodes for Li-ion batteries, as well as to cathodes including those compounds and to Li-ion batteries including those cathodes.

### 2. Description of the Related Art

A high capacity cathode is a key to the realization of high-energy-density lithium-ion batteries.

Due to their high specific capacities beyond 250 mAh g⁻¹, lithium-rich oxides have been considered as promising cathodes for the next generation power batteries, bridging the capacity gap between traditional layered-oxide based lithium-ion batteries and future lithium metal batteries such as lithium sulfur and lithium air batteries.

However, the practical application of Li-rich oxides has been hindered by undesirable capacity and voltage retention caused by irreversible oxygen redox.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

To satisfy the above need, the present disclosure provides materials for use in lithium, manganese-rich (LMR) cathodes for Li-ion batteries, according to embodiments.

In particular, the present disclosure provides doped compounds for use in LMR cathodes for Li-ion batteries.

A first embodiment of the present disclosure provides doped Li_{1.2}Ni_{0.2}Mn_{0.6}O₂, comprising Li_{1.2}Ni_{0.2}Mn_{0.6}O₂ doped with Nat, Li_{1.2}Ni_{0.2}Mn_{0.6}O₂ doped with Co³⁺, or Li_{1.2}Ni_{0.2}Mn_{0.6}O₂ dual doped with Na⁺ and Co³⁺.

A second embodiment of the present disclosure provides a doped Li_{1.2}Ni_{0.2}Mn_{0.6}O₂ of the first embodiment, which is Li_{1.2}Ni_{0.2}Mn_{0.6}O₂ doped with Na⁺.

A third embodiment of the present disclosure provides a doped Li_{1.2}Ni_{0.2}Mn_{0.6}O₂ of the second embodiment, which is Li_{1.175}Na_{0.025}Ni_{0.2}Mn_{0.6}O₂.

A fourth embodiment of the present disclosure provides a doped Li_{1.2}Ni_{0.2}Mn_{0.6}O₂ of the second embodiment, which is Li_{1.15}Na_{0.05}Ni_{0.2}Mn_{0.6}O₂.

A fifth embodiment of the present disclosure provides a doped Li_{1.2}Ni_{0.2}Mn_{0.6}O₂ of the first embodiment, which is Li_{1.2}Ni_{0.2}Mn_{0.6}O₂ doped with Co³⁺.

A sixth embodiment of the present disclosure provides a doped Li_{1.2}Ni_{0.2}Mn_{0.6}O₂ of the fifth embodiment, which is Li_{1.195}Co_{0.025}Ni_{0.195}Mn_{0.585}O₂.

A seventh embodiment of the present disclosure provides a doped Li_{1.2}Ni_{0.2}Mn_{0.6}O₂ of the fifth embodiment, which Li_{1.19}Co_{0.05}Ni_{0.19}Mn_{0.57}O₂.

An eighth embodiment of the present disclosure provides a doped Li_{1.2}Ni_{0.2}Mn_{0.6}O₂ of the first embodiment, which is Li_{1.2}Ni_{0.2}Mn_{0.6}O₂ dual doped with Na⁺ and Co³⁺.

A ninth embodiment of the present disclosure provides a doped Li_{1.2}Ni_{0.2}Mn_{0.6}O₂ of the eighth embodiment, which is Li_{1.17}Na_{0.025}Co_{0.025}Ni_{0.195}Mn_{0.585}O₂.

A tenth embodiment of the present disclosure provides a doped Li_{1.2}Ni_{0.2}Mn_{0.6}O₂ of the eighth embodiment, which is Li_{1.155}Na_{0.0375}Co_{0.0375}Ni_{0.1925}Mn_{0.5775}O₂.

An eleventh embodiment of the present disclosure provides a lithium, manganese-rich cathode comprising the doped Li_{1.2}Ni_{0.2}Mn_{0.6}O₂ of the first embodiment.

A twelfth embodiment of the present disclosure provides a lithium, manganese-rich cathode of the eleventh embodiment, wherein the doped Li_{1.2}Ni_{0.2}Mn_{0.6}O₂ is Li_{1.2}Ni_{0.2}Mn_{0.6}O₂ doped with Na⁺.

A thirteenth embodiment of the present disclosure provides a lithium, manganese-rich cathode of the eleventh embodiment, wherein the doped Li_{1.2}Ni_{0.2}Mn_{0.6}O₂ is Li_{1.2}Ni_{0.2}Mn_{0.6}O₂ doped with Co³⁺.

A fourteenth embodiment of the present disclosure provides a lithium, manganese-rich cathode of the eleventh embodiment, wherein the doped Li_{1.2}Ni_{0.2}Mn_{0.6}O₂ is Li_{1.2}Ni_{0.2}Mn_{0.6}O₂ dual doped with Na⁺ and Co³⁺.

A fifteenth embodiment of the present disclosure provides a lithium-ion battery comprising an anode, a cathode, and an electrolyte, wherein the cathode is a lithium, manganese-rich cathode comprising the doped Li_{1.2}Ni_{0.2}Mn_{0.6}O₂ of the first embodiment.

A sixteenth embodiment of the present disclosure provides a lithium-ion battery of the fifteenth embodiment, wherein the doped Li_{1.2}Ni_{0.2}Mn_{0.6}O₂ is Li_{1.2}Ni_{0.2}Mn_{0.6}O₂ doped with Na⁺.

A seventeenth embodiment of the present disclosure provides a lithium-ion battery of the fifteenth embodiment, wherein the doped Li_{1.2}Ni_{0.2}Mn_{0.6}O₂ is Li_{1.2}Ni_{0.2}Mn_{0.6}O₂ doped with Co³⁺.

An eighteenth embodiment of the present disclosure provides a lithium-ion battery of the fifteenth embodiment, wherein the doped Li_{1.2}Ni_{0.2}Mn_{0.6}O₂ is Li_{1.2}Ni_{0.2}Mn_{0.6}O₂ dual doped with Na⁺ and Co³⁺.

### BRIEF DESCRIPTION OF DRAWINGS

Example embodiments of the present disclosure will be more clearly understood from the following detailed description taken in conjunction with the accompanying drawing in which:

FIG. 1 shows an X-ray diffraction pattern for Na⁺ doped Li_{1.2}Ni_{0.2}Mn_{0.6}O₂ (LNMO1226) embodiments of the present disclosure.

FIG. 2 shows an X-ray diffraction pattern for Co³⁺ doped Li_{1.2}Ni_{0.2}Mn_{0.6}O₂ (LNMO1226) embodiments of the present disclosure.

FIG. 3 shows an X-ray diffraction pattern for Na⁺/Co³⁺ dual doped Li_{1.2}Ni_{0.2}Mn_{0.6}O₂ (LNMO1226) embodiments of the present disclosure.

FIG. 4 shows graphs of specific capacity vs. cycle number and corresponding tables including embodiments of Co³⁺ doped Li_{1.2}Ni_{0.2}Mn_{0.6}O₂ of the present disclosure.

FIG. 5 shows graphs of specific capacity vs. cycle number and corresponding tables including embodiments of Na⁺ doped Li_{1.2}Ni_{0.2}Mn_{0.6}O₂ of the present disclosure.

FIG. 6 shows graphs of specific capacity vs. cycle number and corresponding tables including embodiments of Na⁺ Co³⁺ dual doped Li_{1.2}Ni_{0.2}Mn_{0.6}O₂ of the present disclosure.

FIG. 7 is a graph showing the specific capacity for Na doped, Co doped, and Na/Co doped embodiments of the present disclosure compared with embodiments doped with other dopants.

### DETAILED DESCRIPTION OF EXAMPLE EMBODIMENTS

As mentioned above, the present disclosure provides doped compounds for use in LMR cathodes for Li-ion batteries.

The major concern for lithium, manganese-rich (LMR) cathodes is the low capacity retention when charging to high voltages (>4.7V). To facilitate the industry application of LMR, the LMR cathode is only charged to high voltage in the formation cycle and cycles within a narrow voltage window (2-4.5V or 2.5-4.45V) in the following cycles. Although the retention can be improved, the capacity and energy density are compromised. The present disclosure addresses this issue experimentally by high-throughput screening suitable dopants for improving capacity within a narrow cycling window. It was found that Nat, Co³⁺ and their dual doping can dramatically increase the capacity, without sacrificing retention. This new finding is significantly different than the single dopant strategy reported in the literature as the strategy of the present disclosure uses dual dopants in some embodiments of the present disclosure. The combination of Na⁺ and Co³⁺ further improves the electrochemical performance compared with a single dopant such as Ca²⁺.

Thus, Na⁺ and Co³⁺ dual dopants are applied in LMR Li_{1.2}Ni_{0.2}Mn_{0.6}O₂ in some embodiments of the present disclosure. The capacity increases with this strategy. In particular, the initial capacity is improved by Na⁺ and Co³⁺ dual dopants in Li_{1.2}Ni_{0.2}Mn_{0.6}O₂.

The lithium-containing oxide in this disclosure can be made by a solid-state method and doped by a doping method in the art, except that the doping is with two dopants rather than a single dopant in some embodiments of the present disclosure. A cathode can then be formed from by a cathode manufacturing method in the art, except that the material used to form the cathode is the dual doped lithium-containing oxide in some embodiments of the present disclosure rather than another material.

The cathode can then be used in a lithium-ion battery comprising an anode, a cathode, and an electrolyte, particularly a high-energy Li-ion battery. The battery can be formed by a battery manufacturing method in the art, except that the cathode used to form the battery is a cathode of the present disclosure, which contains the dual doped lithium-containing oxide in some embodiments of the present disclosure rather than another material.

Specific embodiments of the present disclosure were synthesized and tested according to the following synthesis and test protocol for doped Li_{1.2}Ni_{0.2}Mn_{0.6}O₂ (LNMO1226).

In a total of 500 mg Ni_{0.25}Mn_{0.75}(OH)₂, Li₂CO₃ (5% excess to compensate the Li loss at high temperature) and Na₂CO₃ and/or Co₃O₄ were dosed into crucibles and mixed as appropriate for Na doped, Co doped, and NaCo doped embodiments.

To synthesize LNMO1266, the temperature was ramped to 600° C. within 2 h and held at 600° C. for 1h before ramping to the final sinter temperature (950° C.) and holding for 12 h.

The product was ground by hand in mortar and pestle to reduce the agglomeration.

350 mg of product was mixed with 100 mg carbon and 1g 5% PVDF/NMP by a Thinky mixer.

The slurry was cast on Al foil and dried overnight before calendering and punching to make coin cells.

The specific embodiments of the present disclosure will now be described by way of the figures.

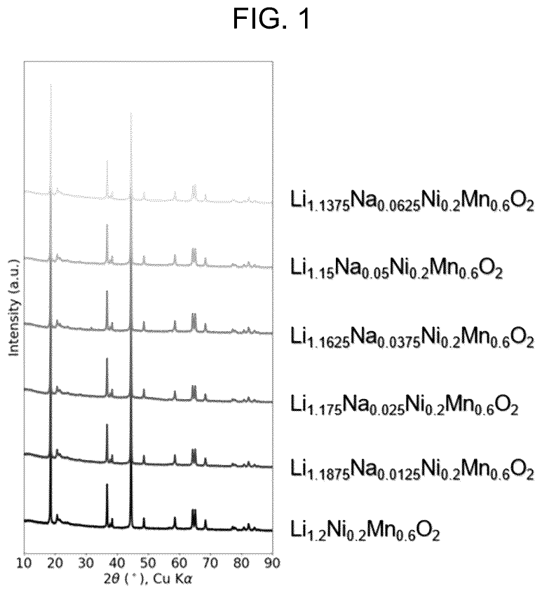

FIG. 1 is an X-ray diffraction pattern for Na⁺ doped Li_{1.2}Ni_{0.2}Mn_{0.6}O₂ (LNMO1226) embodiments of the present disclosure showing high phase purity, namely, Li_{1.1875}Na_{0.0125}Ni_{0.2}Mn_{0.6}O₂, Li_{1.175}Na_{0.025}Ni_{0.2}Mn_{0.6}O₂, Li_{1.1625}Na_{0.0375}Ni_{0.2}Mn_{0.6}O₂, Li_{1.15}Na_{0.05}Ni_{0.2}Mn_{0.6}O₂, and Li_{1.1375}Na_{0.0625}Ni_{0.2}Mn_{0.6}O₂, as well as undoped Li_{1.2}Ni_{0.2}Mn_{0.6}O₂ for comparison.

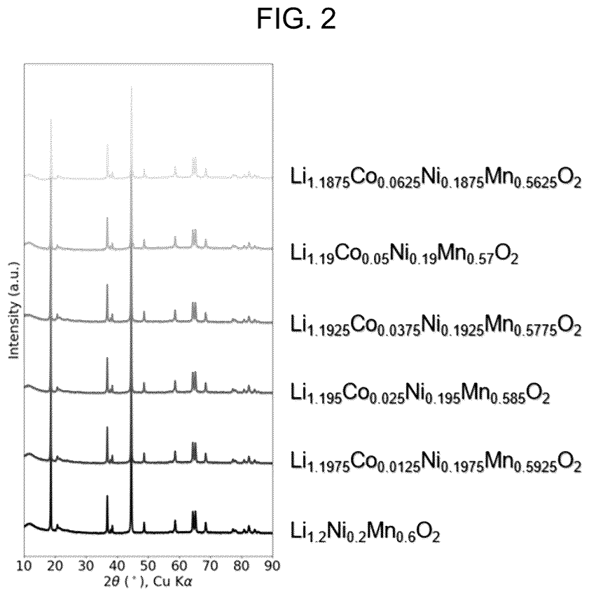

FIG. 2 is an X-ray diffraction pattern for Co³⁺ doped Li_{1.2}Ni_{0.2}Mn_{0.6}O₂ (LNMO1226) embodiments of the present disclosure showing high phase purity, namely, Li_{1.1975}Co_{0.0125}Ni_{0.1975}Mn_{0.5925}O₂, Li_{1.195}Co_{0.025}Ni_{0.195}Mn_{0.585}O₂, Li_{1.1925}Co_{0.0375}Ni_{0.1925}Mn_{0.5775}O₂, Li_{1.19}Co_{0.05}Ni_{0.19}Mn_{0.57}O₂, and Li_{1.1875}Co_{0.0625}Ni_{0.1875}Mn_{0.5625}O₂, as well as undoped Li_{1.2}Ni_{0.2}Mn_{0.6}O₂ for comparison.

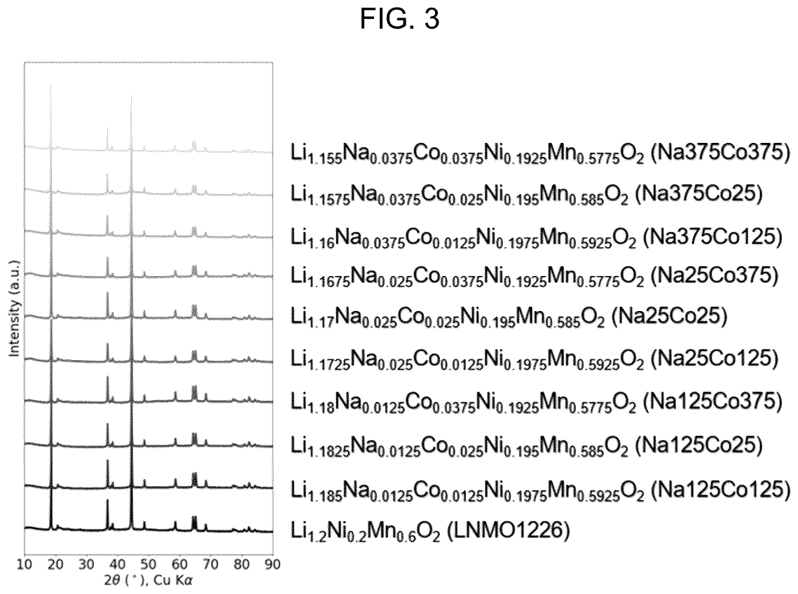

FIG. 3 is an X-ray diffraction pattern for Na⁺/Co³⁺ dual doped Li_{1.2}Ni_{0.2}Mn_{0.6}O₂ (LNMO1226) embodiments of the present disclosure showing high phase purity, namely, Li_{1.185}Na_{0.0125}Co_{0.0125}Ni_{0.1975}Mn_{0.5925}O₂, Li_{1.1825}Na_{0.0125}Co_{0.025}Ni_{0.195}Mn_{0.585}O₂, Li_{1.18}Na_{0.0125}Co_{0.0375}Ni_{0.1925}Mn_{0.5775}O₂, Li_{1.1725}Na_{0.025}Co_{0.0125}Ni_{0.1975}Mn_{0.5925}O₂, Li_{1.17}Na_{0.025}Co_{0.025}Ni_{0.195}Mn_{0.585}O₂, Li_{1.1675}Na_{0.025}Co_{0.0375}Ni_{0.1925}Mn_{0.5775}O₂, Li_{1.16}Na_{0.0375}Co_{0.0125}Ni_{0.1975}Mn_{0.5925}O₂, Li_{1.1575}Na_{0.0375}Co_{0.025}Ni_{0.195}Mn_{0.585}O₂, and Li_{1.155}Na_{0.0375}Co_{0.0375}Ni_{0.1925}Mn_{0.5775}O₂, as well as undoped Li_{1.2}Ni_{0.2}Mn_{0.6}O₂ for comparison.

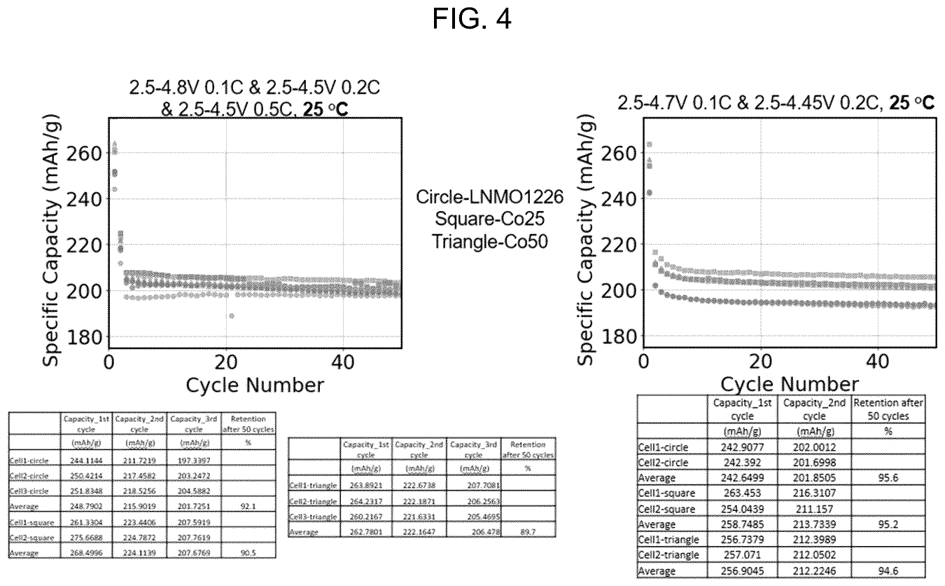

FIG. 4 shows graphs of specific capacity vs. cycle number (wherein the battery is only charged to a high voltage of 4.8V in the formation cycle and is charged within a narrow voltage window of 2.5 to 4.5V in subsequent cycles, or wherein the battery is only charged to a high voltage of 4.7V in the formation cycle and is charged within a narrow voltage window of 2.5 to 4.45V subsequently) and corresponding tables including Co³⁺ doped embodiments of the present disclosure, namely, Li_{1.195}Co_{0.025}Ni_{0.195}Mn_{0.585}O₂ (Co25) and Li_{1.19}Co_{0.05}Ni_{0.19}Mn_{0.57}O₂ (Co50), as well as Li_{1.2}Ni_{0.2}Mn_{0.6}O₂ (LNMO1226). FIG. 4 shows that Co³⁺ doping decreases retention, but it is still basically >90% after 50 cycles, as can also be seen from the results shown in Tables 1A and 1B below.

TABLE 1A
Co³⁺ doping, 2.5-4.8 V 0.1C & 2.5-4.5
V 0.2C & 2.5-4.5 V 0.5C, 25° C.

| | | | | Retention |
|---|---|---|---|---|
| | Capacity_{—} | Capacity_{—} | Capacity_{—} | after 50 |
| | 1st cycle | 2nd cycle | 3rd cycle | cycles |
| | (mAh/g) | (mAh/g) | (mAh/g) | % |
| LNMO1226 | | | | |
| Cell1 | 244.1144 | 211.7219 | 197.3397 | |
| Cell2 | 250.4214 | 217.4582 | 203.2472 | |
| Cell3 | 251.8348 | 218.5256 | 204.5882 | |
| Average | 248.7902 | 215.9019 | 201.7251 | 92.1 |
| Co25 | | | | |
| Cell1 | 261.3304 | 223.4406 | 207.5919 | |
| Cell2 | 275.6688 | 224.7872 | 207.7619 | |
| Average | 268.4996 | 224.1139 | 207.6769 | 90.5 |
| Co50 | | | | |
| Cell1 | 263.8921 | 222.6738 | 207.7081 | |
| Cell2 | 264.2317 | 222.1871 | 206.2563 | |
| Cell3 | 260.2167 | 221.6331 | 205.4695 | |
| Average | 262.7801 | 222.1647 | 206.478 | 89.7 |

TABLE 1B
Co³⁺ doping, 2.5-4.7 V 0.1C & 2.5-4.45 V 0.2C, 25° C.

| | | | Retention |
|---|---|---|---|
| | Capacity_1st | Capacity_2nd | after 50 |
| | cycle | cycle | cycles |
| | (mAh/g) | (mAh/g) | % |
| LNMO1226 | | | |
| Cell1 | 242.9077 | 202.0012 | |
| Cell2 | 242.392 | 201.6998 | |
| Average | 242.6499 | 201.8505 | 95.6 |
| Co25 | | | |
| Cell1 | 263.453 | 216.3107 | |
| Cell2 | 254.0439 | 211.157 | |
| Average | 258.7485 | 213.7339 | 95.2 |
| Co50 | | | |
| Cell1 | 256.7379 | 212.3989 | |
| Cell2 | 257.071 | 212.0502 | |
| Average | 256.9045 | 212.2246 | 94.6 |

As can be seen from the results presented above, Co³⁺ doping decreases retention, but it is still basically >90% after 50 cycles.

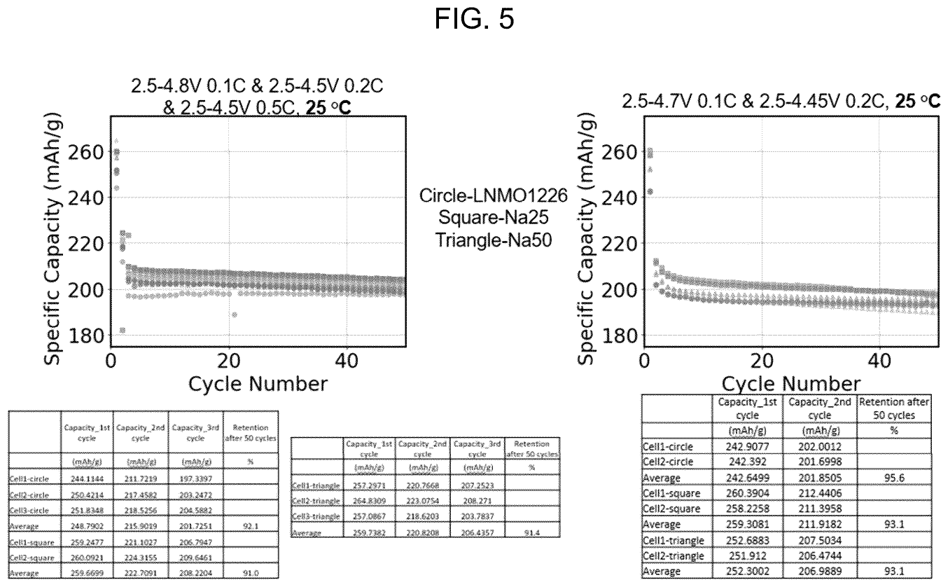

FIG. 5 shows graphs of specific capacity vs. cycle number (wherein the battery is only charged to a high voltage of 4.8V in the formation cycle and is charged within a narrow voltage window of 2.5 to 4.5V in subsequent cycles, or wherein the battery is only charged to a high voltage of 4.7V in the formation cycle and is charged within a narrow voltage window of 2.5 to 4.45V subsequently) and corresponding tables including Na⁺ doped embodiments of the present disclosure, namely, Li_{1.175}Na_{0.025}Ni_{0.2}Mn_{0.6}O₂ (Na25) and Li_{1.15}Na_{0.05}Ni_{0.2}Mn_{0.6}O₂ (Na50), as well as Li_{1.2}Ni_{0.2}Mn_{0.6}O₂ (LNMO1226). FIG. 5 shows that Na⁺ doping decreases retention, but it is still >90% after 50 cycles, as can also be seen from the results shown in Tables 2A and 2B below.

TABLE 2A
Na⁺ doping, 2.5-4.8 V 0.1C & 2.5-4.5
V 0.2C & 2.5-4.5 V 0.5C, 25° C.

| | | | | Retention |
|---|---|---|---|---|
| | Capacity_{—} | Capacity_{—} | Capacity_{—} | after 50 |
| | 1st cycle | cycle 2nd | 3rd cycle | cycles |
| | (mAh/g) | (mAh/g) | (mAh/g) | % |
| LNMO1226 | | | | |
| Cell1 | 244.1144 | 211.7219 | 197.3397 | |
| Cell2 | 250.4214 | 217.4582 | 203.2472 | |
| Cell3 | 251.8348 | 218.5256 | 204.5882 | |
| Average | 248.7902 | 215.9019 | 201.7251 | 92.1 |
| Na25 | | | | |
| Cell1 | 259.2477 | 221.1027 | 206.7947 | |
| Cell2 | 260.0921 | 224.3155 | 209.6461 | |
| Average | 259.6699 | 222.7091 | 208.2204 | 91.0 |
| Na50 | | | | |
| Cell1 | 257.2971 | 220.7668 | 207.2523 | |
| Cell2 | 264.8309 | 223.0754 | 208.271 | |
| Cell3 | 257.0867 | 218.6203 | 203.7837 | |
| Average | 259.7382 | 220.8208 | 206.4357 | 91.4 |

TABLE 2B
Na⁺ doping, 2.5-4.7 V 0.1C & 2.5-4.45 V 0.2C, 25° C.

| | | | Retention |
|---|---|---|---|
| | Capacity_1st | Capacity_2nd | after 50 |
| | cycle | cycle | cycles |
| | (mAh/g) | (mAh/g) | % |
| LNMO1226 | | | |
| Cell1 | 242.9077 | 202.0012 | |
| Cell2 | 242.392 | 201.6998 | |
| Average | 242.6499 | 201.8505 | 95.6 |
| Na25 | | | |
| Cell1 | 260.3904 | 212.4406 | |
| Cell2 | 258.2258 | 211.3958 | |
| Average | 259.3081 | 211.9182 | 93.1 |
| Na50 | | | |
| Cell1 | 252.6883 | 207.5034 | |
| Cell2 | 251.912 | 206.4744 | |
| Average | 252.3002 | 206.9889 | 93.1 |

As can be seen from the results presented above, Na⁺ doping decreases retention, but it is still >90% after 50 cycles.

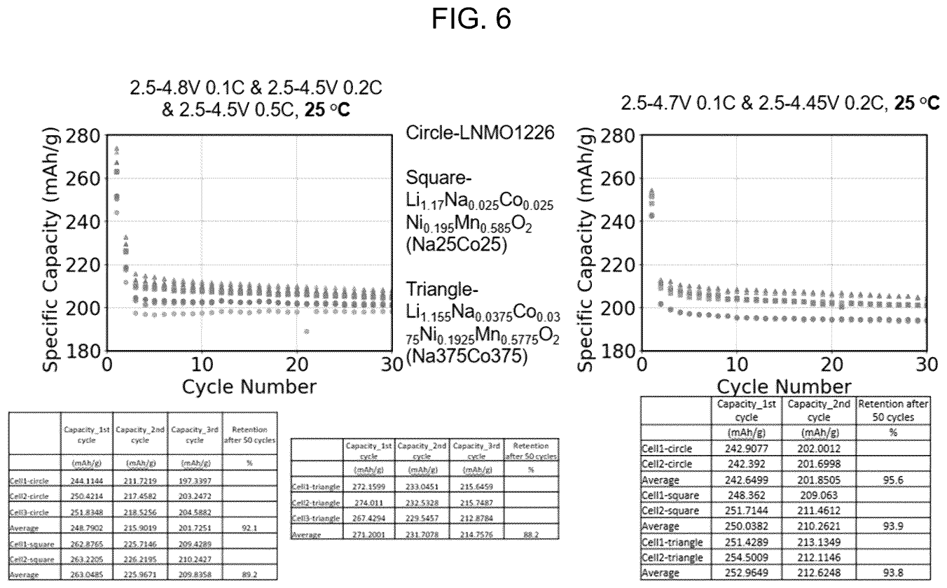

FIG. 6 shows graphs of specific capacity vs. cycle number (wherein the battery is only charged to a high voltage of 4.8V in the formation cycle and is charged within a narrow voltage window of 2.5 to 4.5V in subsequent cycles, or wherein the battery is only charged to a high voltage of 4.7V in the formation cycle and is charged within a narrow voltage window of 2.5 to 4.45V subsequently) and corresponding tables including Na⁺ Co³⁺ dual doped embodiments of the present disclosure, namely, Li_{1.17}Na_{0.025}Co_{0.025}Ni_{0.195}Mn_{0.585}O₂ (Na25Co25) and Li_{1.155}Na_{0.0375}Co_{0.0375}Ni_{0.1925}Mn_{0.5775}O₂ (Na375Co375), as well as a comparison embodiment, namely. Li_{1.2}Ni_{0.2}Mn_{0.6}O₂ (LNMO1226). FIG. 6 shows that Na⁺Co³⁺ dual doping increases the capacity. as can also be seen from the results shown in Table 3A and 3B below.

TABLE 3A
Na⁺Co³⁺ doping, 2.5-4.8 V 0.1C & 2.5-4.5
V 0.2C & 2.5-4.5 V 0.5C, 25° C.

| | | | | Retention |
|---|---|---|---|---|
| | Capacity_{—} | Capacity_{—} | Capacity_{—} | after 50 |
| | 1st cycle | 2nd cycle | 3rd cycle | cycles |
| | (mAh/g) | (mAh/g) | (mAh/g) | % |
| LNMO1226 | | | | |
| Cell1 | 244.1144 | 211.7219 | 197.3397 | |
| Cell2 | 250.4214 | 217.4582 | 203.2472 | |
| Cell3 | 251.8348 | 218.5256 | 204.5882 | |
| Average | 248.7902 | 215.9019 | 201.7251 | 92.1 |
| Na25Co25 | | | | |
| Cell1 | 262.8765 | 225.7146 | 209.4289 | |
| Cell2 | 263.2205 | 226.2195 | 210.2427 | |
| Average | 263.0485 | 225.9671 | 209.8358 | 89.2 |
| Na375Co375 | | | | |
| Cell1 | 272.1599 | 233.0451 | 215.6459 | |
| Cell2 | 274.011 | 232.5328 | 215.7487 | |
| Cell3 | 267.4294 | 229.5457 | 212.8784 | |
| Average | 271.2001 | 231.7078 | 214.7576 | 88.2 |

TABLE 3B
Na⁺Co³⁺ doping, 2.5-4.7 V 0.1C & 2.5-4.45 V 0.2C, 25° C.

| | | | Retention |
|---|---|---|---|
| | Capacity 1_st | Capacity_2nd | after 50 |
| | cycle | cycle | cycles |
| | (mAh/g) | (mAh/g) | % |
| LMNO1226 | | | |
| Cell1 | 242.9077 | 202.0012 | |
| Cell2 | 242.392 | 201.6998 | |
| Average | 242.6499 | 201.8505 | 95.6 |
| Na25Co25 | | | |
| Cell1 | 248.362 | 209.063 | |
| Cell2 | 251.7144 | 211.4612 | |
| Average | 250.0382 | 210.2621 | 93.9 |
| Na375Co375 | | | |
| Cell1 | 251.4289 | 213.1349 | |
| Cell2 | 254.5009 | 212.1146 | |
| Average | 252.9649 | 212.6248 | 93.8 |

As can be seen from the results presented above, Na⁺Co³⁺ dual doping according to the present disclosure increases the capacity.

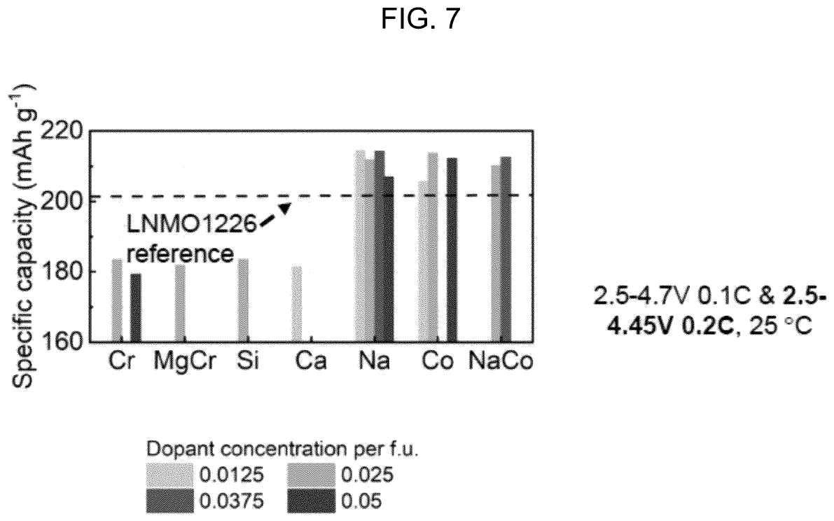

FIG. 7 is a graph showing the specific capacity for Na doped, Co doped, and NaCo doped embodiments of the present disclosure compared with embodiments doped with other dopants. As can be seen from FIG. 7, the Na doping, Co doping, and NaCo dual doping of the present disclosure provide excellent results as compared with other doped embodiments, particularly embodiments based on either single doping with any of Cr, Si, and Ca or dual doping with MgCr.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

1.-18. (canceled)

19. A lithium-ion battery comprising an anode, a cathode, and an electrolyte, wherein the cathode comprises Li_{1.2}Ni_{0.2}Mn_{0.6}O₂ doped with Na⁺, Li_{1.2}Ni_{0.2}Mn_{0.6}O₂ doped with Co³⁺, or Li_{1.2}Ni_{0.2}Mn_{0.6}O₂ dual doped with Na⁺ and Co³⁺.

20. The lithium-ion battery of claim 19, wherein the doped Li_{1.2}Ni_{0.2}Mn_{0.6}O₂ is Li_{1.2}Ni_{0.2}Mn_{0.6}O₂ doped with Na⁺.

21. The lithium-ion battery of claim 20, wherein the doped Li_{1.2}Ni_{0.2}Mn_{0.6}O₂ is Li_{1.175}Na_{0.025}Ni_{0.2}Mn_{0.6}O₂.

22. The lithium-ion battery of claim 20, wherein the doped Li_{1.2}Ni_{0.2}Mn_{0.6}O₂ is Li_{1.15}Na_{0.05}Ni_{0.2}Mn_{0.6}O₂.

23. The lithium-ion battery of claim 19, wherein the doped Li_{1.2}Ni_{0.2}Mn_{0.6}O₂ is Li_{1.2}Ni_{0.2}Mn_{0.6}O₂ doped with Co³⁺.

24. The lithium-ion battery of claim 23, wherein the doped Li_{1.2}Ni_{0.2}Mn_{0.6}O₂ is Li_{1.195}Co_{0.025}Ni_{0.195}Mn_{0.585}O₂.

25. The lithium-ion battery of claim 23, wherein the doped Li_{1.2}Ni_{0.2}Mn_{0.6}O₂ is Li_{1.19}Co_{0.05}Ni_{0.19}Mn_{0.57}O₂.

26. The lithium-ion battery of claim 19, wherein the doped Li_{1.2}Ni_{0.2}Mn_{0.6}O₂ is dual doped with Na⁺ and Co³⁺.

27. The lithium-ion battery of claim 26, wherein the doped Li_{1.2}Ni_{0.2}Mn_{0.6}O₂ is Li_{1.17}Na_{0.025}Co_{0.025}Ni_{0.195}Mn_{0.585}O₂.

28. The lithium-ion battery of claim 26, wherein the doped Li_{1.2}Ni_{0.2}Mn_{0.6}O₂ is Li_{1.155}Na_{0.0375}Co_{0.0375}Ni_{0.1925}Mn_{0.5775}O₂.

29. Doped Li_{1.2}Ni_{0.2}Mn_{0.6}O₂, comprising Li_{1.2}Ni_{0.2}Mn_{0.6}O₂ doped with Na⁺, Li_{1.2}Ni_{0.2}Mn_{0.6}O₂ doped with Co³⁺, or Li_{1.2}Ni_{0.2}Mn_{0.6}O₂ dual doped with Na⁺ and Co³⁺.

30. The doped Li_{1.2}Ni_{0.2}Mn_{0.6}O₂ of claim 29, wherein the doped Li_{1.2}Ni_{0.2}Mn_{0.6}O₂ is Li_{1.2}Ni_{0.2}Mn_{0.6}O₂ doped with Na⁺.

31. The doped Li_{1.2}Ni_{0.2}Mn_{0.6}O₂ of claim 30, wherein the doped Li_{1.2}Ni_{0.2}Mn_{0.6}O₂ is Li_{1.175}Na_{0.025}Ni_{0.2}Mn_{0.6}O₂.

32. The doped Li_{1.2}Ni_{0.2}Mn_{0.6}O₂ of claim 30, wherein the doped Li_{1.2}Ni_{0.2}Mn_{0.6}O₂ is Li_{1.15}Na_{0.05}Ni_{0.2}Mn_{0.6}O₂

33. The doped Li_{1.2}Ni_{0.2}Mn_{0.6}O₂ of claim 29, wherein the doped Li_{1.2}Ni_{0.2}Mn_{0.6}O₂ is Li_{1.2}Ni_{0.2}Mn_{0.6}O₂ doped with Co³⁺.

34. The doped Li_{1.2}Ni_{0.2}Mn_{0.6}O₂ of claim 33, wherein the doped Li_{1.2}Ni_{0.2}Mn_{0.6}O₂ is Li_{1.195}Co_{0.025}Ni_{0.195}Mn_{0.585}O₂.

35. The doped Li_{1.2}Ni_{0.2}Mn_{0.6}O₂ of claim 33, wherein the doped Li_{1.2}Ni_{0.2}Mn_{0.6}O₂ is Li_{1.19}Co_{0.05}Ni_{0.19}Mn_{0.57}O₂.

36. The doped Li_{1.2}Ni_{0.2}Mn_{0.6}O₂ of claim 29, wherein the doped Li_{1.2}Ni_{0.2}Mn_{0.6}O₂ is dual doped with Na⁺ and Co³⁺.

37. The doped Li_{1.2}Ni_{0.2}Mn_{0.6}O₂ of claim 36, wherein the doped Li_{1.2}Ni_{0.2}Mn_{0.6}O₂ is Li_{1.17}Na_{0.025}Co_{0.025}Ni_{0.195}Mn_{0.585}O₂.

38. The doped Li_{1.2}Ni_{0.2}Mn_{0.6}O₂ of claim 36, wherein the doped Li_{1.2}Ni_{0.2}Mn_{0.6}O₂ is Li_{1.155}Na_{0.0375}Co_{0.0375}Ni_{0.1925}Mn_{0.5775}O₂.
